(19) United States
(12) Patent Application Publication
(10) Pub. No.: US 2019/0128193 A1
(43) Pub. Date: May 2, 2019

(54) ELECTRIC AIR FLOW CONTROL DEVICE

(71) Applicant: NIKKI CO., LTD., Atsugi-Shi (JP)

(72) Inventor: Shinya Yamaguchi, Kanagawa-ken (JP)

(21) Appl. No.: 16/006,819

(22) Filed: Jun. 12, 2018

(30) Foreign Application Priority Data
Nov. 2, 2017 (JP) 2017-213239

(51) Int. Cl. F02D 9/10; F02D 9/02

(52) U.S. Cl. CPC F02D 9/1065; F02D 9/02

(57) ABSTRACT

In an electric air flow control device for controlling the flow rate of air supplied to an engine, a drive unit and a throttle unit are formed separately from each other, and the drive unit and the throttle unit are integrally connected to open and close a throttle valve by a motor. An outer ring of a bearing attached to a rotating shaft of the throttle valve is used as a spigot joint to be inserted into both of a recess formed in the drive unit and a recess formed in the throttle unit, and the concentricity of the rotating shaft is obtained between the drive unit and the throttle unit.

### CROSS-REFERENCE TO RELATED APPLICATION

This application claims priority to Japanese Application JP 2017-213239 filed on Nov. 2, 2017, the contents of which are hereby incorporated by reference in its entirety.

### TECHNICAL FIELD

The present invention relates to an air flow control device which controls the flow rate of air supplied to an engine and more particularly to an electric air flow control device in which a drive unit and a throttle unit separately formed are integrally connected to each other to open and close a throttle valve by a motor.

Conventionally, in two-wheeled vehicles and other general-purpose engines, the mounting method of a throttle body differs depending on such as the exhaust volume and the number of cylinders, and throttle bodies nearly equal to the number of engines are included.

### BACKGROUND

On the other hand, in recent years, for example, as disclosed in such as JP 2004-510911 A (PTL 1), it is known that, to strictly regulate emissions and to improve convenience, measures have been taken to electronically control a throttle valve opening to further finely control an engine rotation speed, as a means for controlling the throttle valve, a drive unit having a motor and gears and a throttle unit having the throttle valve are separately formed, the angle is accurately controlled by combining these, and the flow rate of air supplied to an engine is adjusted to control an engine.

In the invention described in PTL 1, as illustrated in FIG. 8, by separately manufacturing a drive unit 1a and a throttle unit 2a and integrally connecting them, the drive unit can be shared among various kinds of products, and the structure of the throttle unit can also be simplified. As a result, design and manufacturing costs can be reduced.

However, in the case of combining the drive unit and the throttle unit which are separately manufactured as described above, there is a possibility that a core shake may occur when the rotating shaft of a throttle valve is inserted and connected to the drive unit.

In automotive applications, these components need to be covered with a sealing cover to protect them from rainwater and dust. However, in the case of complete sealing, if the internal pressure changes due to temperature change, and the sealing is insufficient, the components sometimes absorb such as rainwater.

On the other hand, general-purpose engines used in outdoor non-paved roads such as lawn mowers are expected to be used in a dusty environment and to be washed with a high pressure washing machine frequently. Therefore, it is thought that rainwater and dust are likely to enter from a ventilation hole in a cover, and waterproofing/dustproofing performance is particularly strongly required.

### SUMMARY

An object of the present invention is to provide an electric air flow control device for controlling the flow rate of air supplied to an engine, in which a drive unit and a throttle unit are separately formed to facilitate commonization of parts, accurately connect a rotating shaft of a throttle valve to the drive unit without having a core shake and further prevent rainwater and sand dust from entering into the drive unit.

According to the present invention made to solve the above-described problems, in an electric air flow control device for controlling the flow rate of air supplied to an engine, a drive unit having a motor and a throttle unit having a throttle valve are separately formed, and the drive unit and the throttle unit are integrally connected to open and close the throttle valve by the motor. An outer ring of a bearing attached to a rotating shaft of the throttle valve is used as a spigot joint to be inserted into both a recess formed in the drive unit and a recess formed in the throttle unit, and the concentricity of the rotating shaft is obtained between the drive unit and the throttle unit.

In addition, when the bearing is a ball bearing, it is preferable in terms of accuracy and cost since bearings with high manufacturing precision and easy to used.

Further, the drive unit is brought into close contact with the throttle unit by a sealing material excluding a rotating shaft insertion hole disposed on a lower surface, and the rotating shaft insertion hole communicates with a ventilation groove formed in the recess of the drive unit, a ventilation groove formed in the recess of the throttle unit, and a ventilation hole formed at the upstream position of the throttle valve in the throttle unit. In this case, since the inside of the drive unit is maintained at a pressure almost equal to the atmospheric pressure by the ventilation grooves and the ventilation hole, waterproofing/dustproofing effects can be exerted without causing a change in internal pressure due to temperature change, for example.

According to the electric air flow control device of the present invention, by using an outer ring of a bearing as a spigot joint to be inserted into recesses of both the drive unit and the throttle unit, a rotating shaft is certainly positioned between the drive unit and the throttle unit to prevent occurrence of core shake.

Further, by providing a ventilation groove and a ventilation hole leading into a sealed drive unit, the drive unit communicates with an air cleaner upstream of a throttle valve with the clean and almost atmospheric environment, and the inside of the drive unit is kept clean and substantially at atmospheric pressure. As a result, for example, without causing a change in internal pressure due to temperature change, it is possible to prevent rainwater and sand dust from entering into the drive unit. Further, by forming the ventilation groove and the ventilation hole inside in advance, extra piping is not needed, and it is possible to contribute to reduction in the number of parts and cost saving.

### BRIEF DESCRIPTION OF DRAWINGS

FIG. 1 is a perspective view illustrating a preferred embodiment of an electric air flow control device of the present invention;

FIG. 2 is an exploded perspective view illustrating a state in which a drive unit and a throttle unit according to the embodiment indicated in FIG. 1 are separately formed;

FIG. 3A is a bottom perspective view, and FIG. 3B is a partially enlarged view of the drive unit according to the embodiment of FIG. 1;

FIG. 4A is a top perspective view, and FIG. 4B is a partially enlarged view of the throttle unit according to the embodiment of FIG. 1;

FIG. 5 is a front view illustrating the embodiment of FIG. 1;

FIG. 6 is a cross-sectional view taken along line A-A in which an internal mechanism in FIG. 5 is partially omitted;

FIG. 7 is a partially enlarged view of FIGS. 6; and

FIG. 8 is a view illustrating a conventional example.

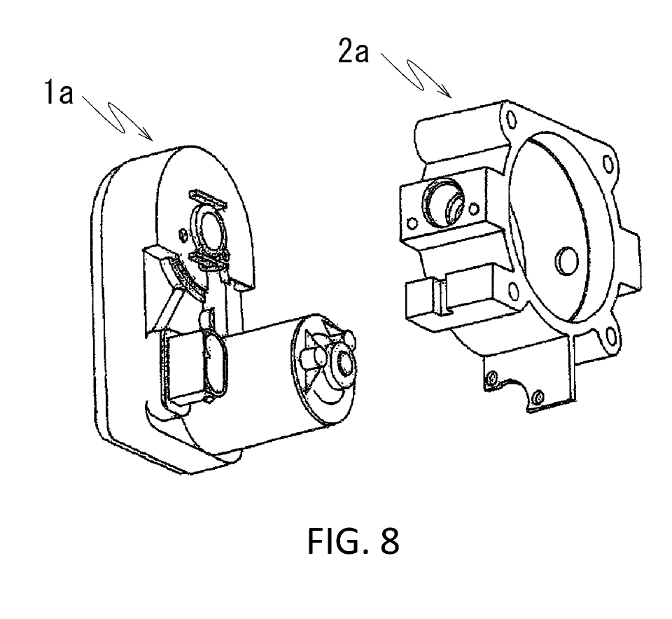

### DETAILED DESCRIPTION

Hereinafter, preferred embodiments of the present invention will be described in detail with reference to the drawings.

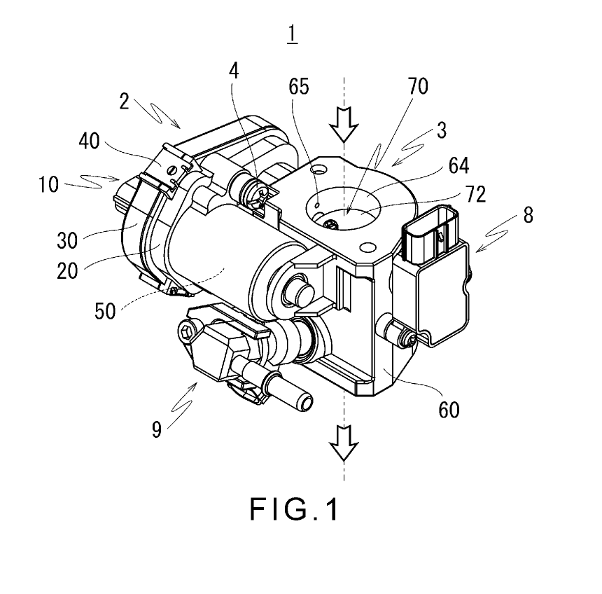

FIG. 1 is a view illustrating a preferred embodiment of the electric air flow control device of the present invention. In an electric air flow control device 1, a drive unit 2 and a throttle unit 3 are integrally assembled. The drive unit 2 accommodates a deceleration mechanism including a motor 50 and a gear (not illustrated) in a housing 10 in which a bracket 20 and a cover 30 are coupled by a clip 40, and a rotating shaft holding member 51 which is connected to the deceleration mechanism. The throttle unit 3 rotatably accommodates a throttle valve 70 including a rotating shaft 71 and a valve body 72 in a throttle body 60.

Incidentally, reference sign 91 denotes a sensor unit for detecting and outputting an opening degree of the throttle valve 70, and reference numeral 92 denotes a fuel supply unit. The description thereof is omitted in this specification.

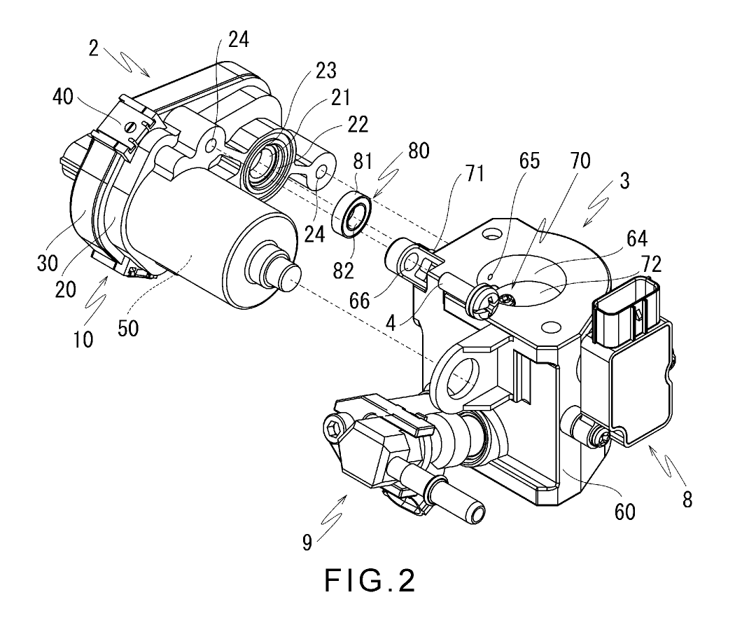

FIG. 2 is an exploded perspective view illustrating a state in which the drive unit 2 and the throttle unit 3 are separately formed according to the preferred embodiment of the present invention.

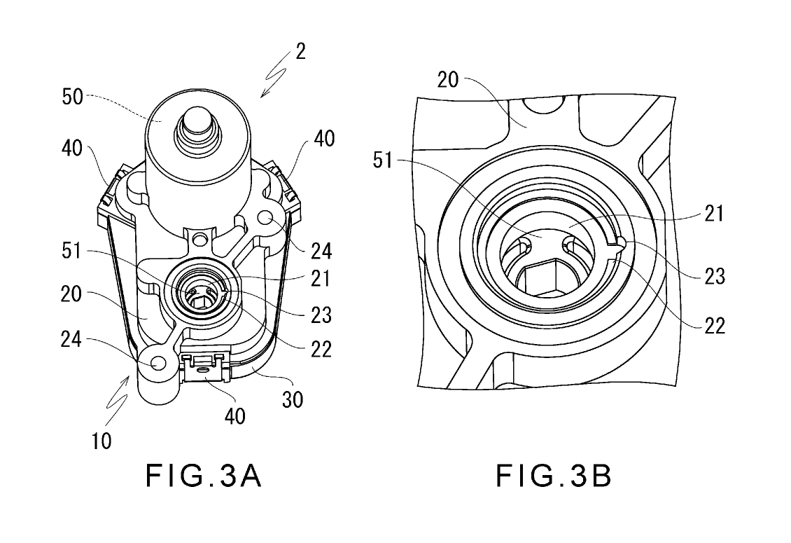

The bracket 20 included in the housing 10 of the drive unit 2 has a rotating shaft insertion hole 21 and a recess 22 which is concentric with the rotating shaft insertion hole 21 and has a larger diameter than the rotating shaft insertion hole 21 on a lower surface, and a ventilation groove 23 is formed in a part of the outer periphery of the upper recess 22 (refer to FIGS. 3A and 3B).

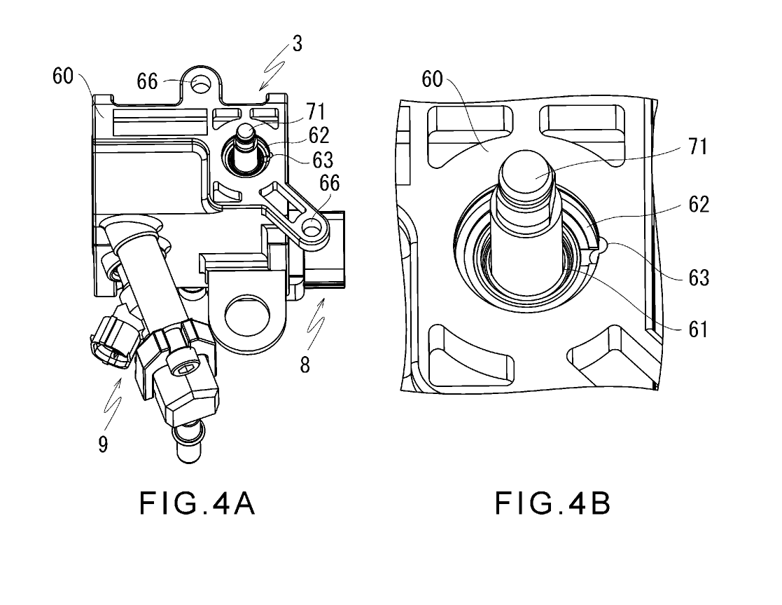

The throttle body 60 of the throttle unit 3 has a rotating shaft insertion hole 61 and a recess 62 which is concentric with the rotating shaft insertion hole 61 and has a larger diameter than the rotating shaft insertion hole 61 on an upper surface, and a ventilation groove 63 is formed in a part of the outer periphery of the recess 62 (refer to FIGS. 4A and 4B).

A ventilation hole 65 formed in communication with the ventilation groove 63 is provided at a position upstream of the throttle valve 70 in a gas flow path 64 formed through the throttle body 60.

In the drive unit 2 and the throttle unit 3, a bearing 80 is attached to the rotating shaft 71 of the throttle valve 70 projecting from the recess 62 of the throttle body 60, and the rotating shaft 71 is inserted into and connected to the rotating shaft holding member 51 accommodated in the housing 10. The drive unit 2 and the throttle unit 3 are integrally fixed by fixing screws 4 and 4 screwed into screw holes 24 and 24 of the bracket 20 via through holes 66 and 66 of the throttle body 60.

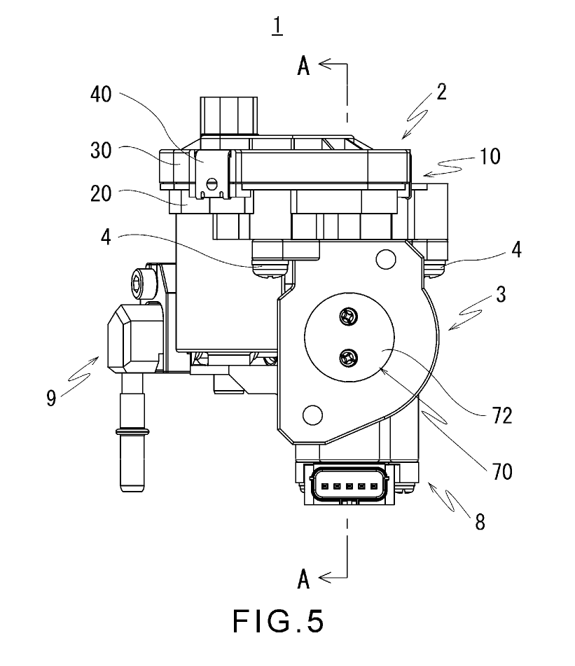

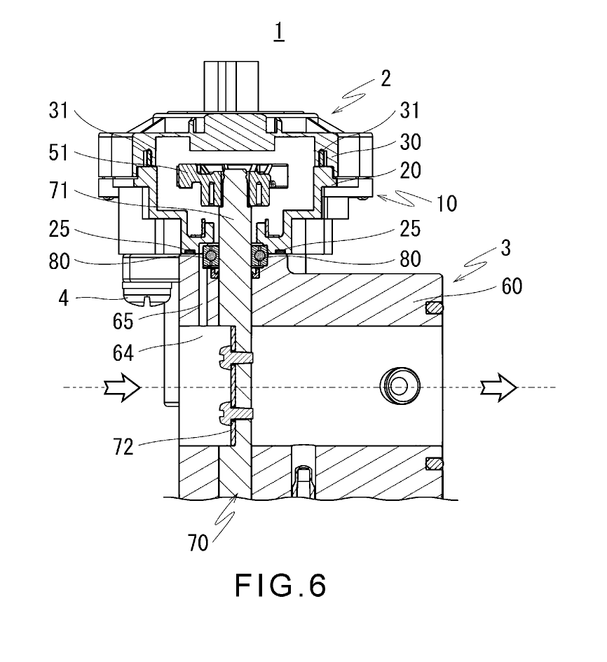

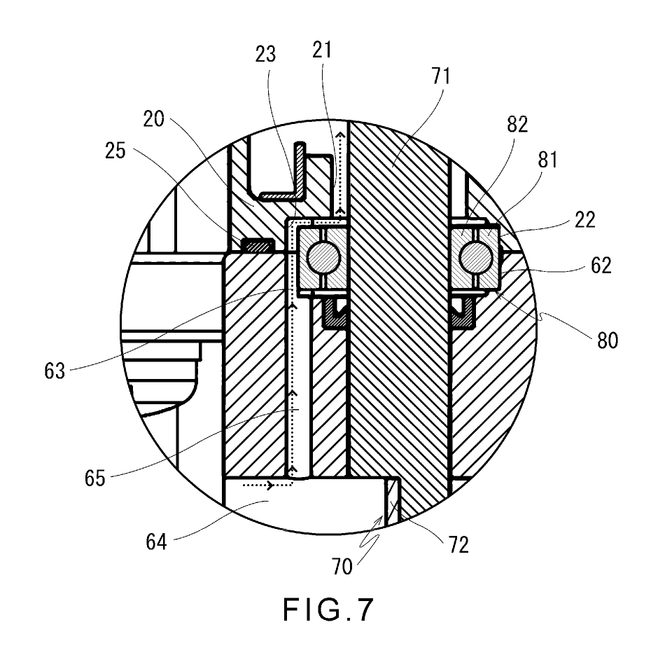

FIG. 6 is a cross-sectional view taken along line A-A in which an internal mechanism illustrated in FIG. 5 is partially omitted, and FIG. 7 is a partially enlarged view of FIG. 6.

As illustrated in FIGS. 6 and 7, an outer ring 81 of the bearing 80 attached to the rotating shaft 71 of the throttle valve 70 is used as a spigot joint to be inserted into both of the recess 62 formed in the throttle body 60 and the recess 22 formed in the bracket 20.

Thereby, it is possible to position the rotating shaft 71 between the drive unit 2 and the throttle unit 3 to secure the concentricity of the rotating shaft 71 and prevent occurrence of core shape.

In this embodiment, it is desirable to use a ball bearing using a steel ball as the bearing 80, since both the outer ring 81 and an inner ring 82 can easily obtain bearings with high precision and excellent durability.

Furthermore, the rotating shaft insertion hole 21 formed in the bracket 20, the ventilation groove 23 formed in the recess 22 of the bracket 20, the ventilation groove 63 formed in the recess 62 of the throttle body 60, and a ventilation hole 65 formed facing the gas flow path 64 of the throttle body 60 are in communication with each other to communicate the gas flow path 64 and the inside of the drive unit 2 sealed by sealing members 25 and 31.

By making the gas flow path 64 communicate with the inside of the drive unit 2 in this manner, it is possible to maintain the inside of the drive unit 2 in a clean state and substantially at atmospheric pressure through a clean and near atmospheric pressure environment between the drive unit 2 and an air cleaner (not illustrated) upstream of the throttle valve 70.

By maintaining the inside of the drive unit 2 in a clean state and substantially at atmospheric pressure, for example, without changing internal pressure due to temperature change, it is possible to prevent rainwater and dust from being sucked into and entering into the drive unit 2. By forming the ventilation grooves 23 and 63 and the ventilation hole 65 inside in advance, extra piping is not needed.

As described above, according to the present invention, by using the outer ring of the bearing as a spigot joint to be inserted into the recesses of both the drive unit and the throttle unit, it is possible to certainly position the rotating shaft between the drive unit and the throttle unit to prevent occurrence of core shake.

Further, by providing a ventilation groove and a ventilation hole leading into a sealed drive unit, the drive unit communicates with an air cleaner upstream of a throttle valve with the clean and almost atmospheric environment, and the inside of the drive unit is maintained clean and substantially at atmospheric pressure. As a result, for example, without causing a change in internal pressure due to temperature change, it is possible to prevent rainwater and sand dust from entering into the drive unit. Further, by forming the ventilation groove and the ventilation hole inside in advance, extra piping is not needed, and it is possible to contribute to reduction in the number of parts and cost saving.

1. An electric air flow control device, comprising:
a drive unit having a motor; and
a throttle unit having a throttle valve,
the electric air flow control device being configured to control a flow rate of air supplied to an engine by integrally connecting the drive unit and the throttle unit to open and close the throttle valve by the motor,
wherein an outer ring of a bearing attached to a rotating shaft of the throttle valve is used as a spigot joint to be inserted into both of a recess formed in the drive unit and a recess formed in the throttle unit, and a concentricity of the rotating shaft is obtained between the drive unit and the throttle unit.

2. The electric air flow control device according to claim 1, wherein the bearing is a ball bearing.

3. The electric air flow control device according to claim 1, wherein the drive unit is brought into close contact with the throttle unit by a sealing material excluding a rotating shaft insertion hole disposed on a lower surface, and the rotating shaft insertion hole communicates with a ventilation groove formed in the recess of the drive unit, a ventilation groove formed in the recess of the throttle unit, and a ventilation hole formed at an upstream position of the throttle valve in the throttle unit.

4. The electric air flow control device according to claim 2, wherein the drive unit is brought into close contact with the throttle unit by a sealing material excluding a rotating shaft insertion hole disposed on a lower surface, and the rotating shaft insertion hole communicates with a ventilation groove formed in the recess of the drive unit, a ventilation groove formed in the recess of the throttle unit, and a ventilation hole formed at an upstream position of the throttle valve in the throttle unit.

5. The electric air flow control device according to claim 1, wherein the drive unit is brought into close contact with the throttle unit by a sealing material excluding a rotating shaft insertion hole disposed on a lower surface.

6. The electric air flow control device according to claim 1, wherein the rotating shaft insertion hole communicates with a ventilation groove formed in the recess of the drive unit.

7. The electric air flow control device according to claim 1, wherein a ventilation groove formed in the recess of the throttle unit.

8. The electric air flow control device according to claim 1, a ventilation hole formed at an upstream position of the throttle valve in the throttle unit.
